(19) United States
(12) Patent Application Publication
(10) Pub. No.: US 2011/0140914 A1
(43) Pub. Date: Jun. 16, 2011

(54) CONTROLLER SYSTEM

(75) Inventors: Yosef Pelech, Tel Aviv (IL); Gad Zilbertrest, Jerusalem (IL)

(73) Assignee: Midori Technologies Ltd., Tel Aviv (IL)

(21) Appl. No.: 13/058,335

(22) PCT Filed: Nov. 22, 2009
(86) PCT No.: PCT/IB09/55266

§ 371 Date: Feb. 10, 2011

Related U.S. Application Data
(60) Provisional application No. 61/117,242, filed on Nov. 24, 2008.

(51) Int. Cl. H04Q 9/00

(52) U.S. Cl. 340/870.07

(57) ABSTRACT

A system and apparatus facilitating enhanced control of apparatus, equipment and appliances. In particular, the present invention relates to a system and apparatus which can be readily retro-fittable to a wide range of appliances thereby enhancing energy saving properties and wear reduction. According to the present invention, there is provided a controller system including a controller apparatus including a power source, a telemetry sensor for readily detecting at least one telemetry reading, a transmitter responsive to signals from the telemetry sensor; and an electrical/electronic apparatus responsive to signals from the transmitter.

### FIELD OF THE INVENTION

The present invention relates to a system and apparatus facilitating enhanced control of apparatus, equipment and appliances. In particular, the present invention relates to a system and apparatus which can be readily retro-fittable to a wide range of appliances thereby enhancing energy saving properties and wear reduction.

### BACKGROUND OF THE INVENTION

There has long existed the need for an apparatus and system whereby a user can control, enhance energy saving and reduce wear of a specific appliance.

Many “energy saving” inventions and methods now exist to ensure that users can use an appliance economically. The present invention introduces a new apparatus and system for achieving a high degree of energy saving, wear reduction and retrofit ability.

Various prior art apparatus and methods have been described and reviewed in earlier U.S. Pat. No. 7,123,139 and U.S. Pat. No. 5,489,827, which are incorporated herein by reference for all purposes as if fully set forth herein.

U.S. Patent No. 7,123,139 (hereinafter: “Sweeney”) describes an occupancy sensor is provided for determining whether a room is occupied. The occupancy sensor integrates a battery-powered PIR motion detector and a battery-powered Hall Effect switch, each of which communicates wirelessly with a controller, in a single housing. According to Sweeney's teachings, a host controller is required in the HVAC (heating, ventilating and cooling) and is limited to HVAC apparatus. However, the disclosed invention still has many disadvantages. Sweeney does not teach a retrofittable apparatus which does not alter the appliance. Moreover, Sweeney teaches away from the possibility of adapting the invention according to Sweeney to any other appliance and/or apparatus and is limited to HVAC apparatus only.

U.S. Pat. No. 5,489,827 (hereinafter: “Xia”) describes a system for controlling the intensity of a lamp including a remote sensing device for detecting the presence of an occupant within an area. The device also transmits a signal based on the currently sensed presence of the occupant. After each transmission of an occupancy signal, the device is inhibited from further transmission for a first predetermined period of time to limit power consumption requirements by the battery powered device. The system also includes a light controller responsive to the transmitted occupancy signal for controlling the level of illumination by the lamp. In the absence of a transmitted occupancy signal within a second predetermined period of time, the light controller will instruct the ballast to reduce the level of illumination by the lamp. In the absence of an occupancy signal being transmitted within a third predetermined time period, the light controller will instruct the ballast to turn off the lamp. Nevertheless, Xia does not teach a retrofittable apparatus which does not alter the appliance and merely teaches the use of the invention in conjunction with illumination devices. Moreover, XIA teaches away from the possibility of adapting the invention according to Sweeney to any other appliance and/or apparatus and is limited to illumination apparatus only.

Although numerous additional inventions of light controlling apparatus are known in the art. Nevertheless, all of the light controlling apparatus teach away from the possibility of adapting the inventions according to the prior art to any other appliance and/or apparatus and is limited to illumination apparatus.

Thus, such inventions as those described above generally suffer from at least one of several disadvantages, including, amongst others, the lack of an ability to use other than lighting systems and the need to add hardware and/or software elements to the apparatus/appliance. Therefore, the need exists to create a system and apparatus whereby the foregoing disadvantages are adequately remedied to provide a readily retrofittable system and apparatus to a wide range of apparatus/appliances and/or not requiring any modifications to any of the apparatus/appliances utilized with the invention.

### SUMMARY OF THE INVENTION

The present invention is controller for controlling domestic and industrial energy consumption, which controller is capable of being manufactured in different sizes for use with any pre-existing domestic environment and industrial environment. The controller is designed to have the capability of replacing a standard motion detector for use with a variety of apparatus and appliances for either domestic use, industrial use or both.

The controller according to the present invention preferably bears a strong visual and physical resemblance to a motion detector.

According to preferred embodiments of the present invention, there is provided a controller system including: a controller apparatus including a power source, a telemetry sensor for readily detecting at least one telemetry reading, a transmitter responsive to signals from the telemetry sensor, and an electrical/electronic apparatus responsive to signals from the transmitter.

According to further embodiments of the present invention, the controller apparatus has a shape recalling that of a motion detector.

According to still further embodiments of the present invention, the transmitter wirelessly communicates with the electrical/electronic apparatus.

According to yet further embodiments of the present invention, the electrical/electronic apparatus is devoid of retrofitting for readily using the controller apparatus with the apparatus.

According to further embodiments of the present invention, the electrical/electronic apparatus is selected from the group consisting of: a HVAC (heating, ventilating and cooling) apparatus, a telephony apparatus, a multimedia apparatus, an audio apparatus, a home theater system, at least one illumination device, a home computer, a portable computer and a PDA.

According to further embodiments of the present invention, there is provided a controller system including: a controller apparatus having a shape recalling that of a motion detector including a power source, a telemetry sensor for readily detecting at least one telemetry reading, a wireless transmitter responsive to signals from the telemetry sensor, an electrical/electronic apparatus devoid of retrofitting to the controller and responsive to at least one signal from the transmitter, wherein the electrical/electronic apparatus is selected from the group consisting of: a HVAC (heating, ventilating and cooling) apparatus, a telephony apparatus, a multimedia apparatus, an audio apparatus, a home theater system, at least one illumination device, a home computer, a portable computer and a PDA.

According to further embodiments of the present invention, the telemetry sensor further including a processor for readily controlling the time and/or operation mode of the electrical/electronic apparatus.

According to still further embodiments of the present invention, illumination device illuminates substantially at a wavelength producing visible red, visible blue, IR or UV illumination.

According to further embodiments of the present invention, the controller apparatus further including a receiver for “two way” telemetry with the controller.

According to further embodiments of the present invention, the at least one signal is compatible with at least one domestic appliance.

According to further embodiments of the present invention, there is provided a controller system including controller apparatus including a power source, and a wireless transmitter, an illuminator electrically attached responsive to at least one signal from the wireless transmitter, and an actuator electrically attached to the illuminator for readily controlling illumination of the illuminator.

### BRIEF DESCRIPTION OF THE DRAWINGS

FIG. 1 is a schematic view of the controller of the present invention in a domestic environment; and

FIG. 2 is a schematic diagram of the components of an embodiment of a controller according to the present invention.

### DETAILED DESCRIPTION OF THE INVENTION

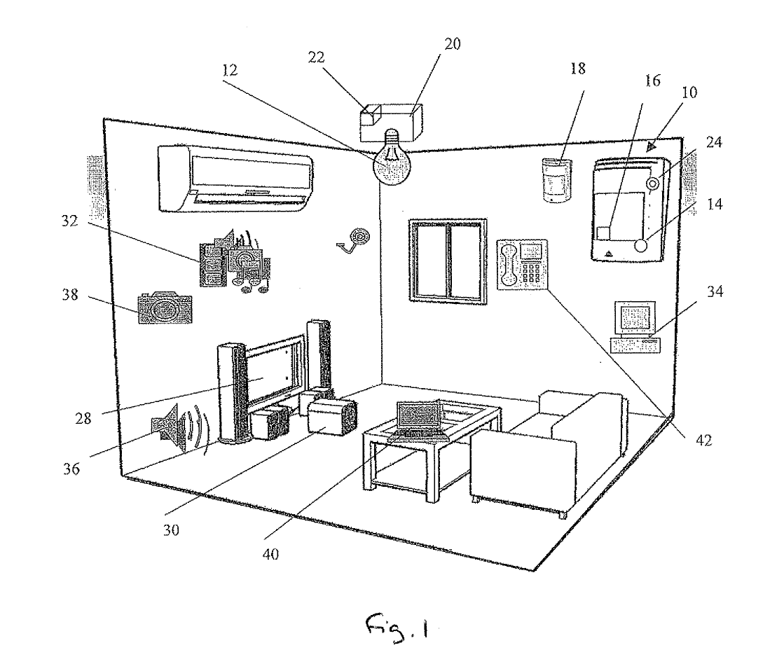

Turning now to the drawings, FIG. 1 shows an embodiment of a controller apparatus 10 in a domestic environment 11. Controller apparatus 10 is preferably electronically attached to, or integrally formed with, at least one electric/electronic apparatus selected from the group consisting of an illuminator 12, a telemetry sensor 14, a transmitter 16. Preferably, controller apparatus 10 is wirelessly attached to at least one electric/electronic apparatus selected from the group consisting of a HVAC (heating, ventilating and cooling) apparatus, a telephony apparatus, a multimedia apparatus, an audio apparatus, a home theater system, at least one illumination device, a home computer, a portable computer and a PDA.

Preferably, illuminator 12 includes an illumination receiver 20 from transmitter 16 for readily controlling illuminator 12 responsively to signals from transmitter 16.

Preferably, illumination receiver 20 is attached to or integrally formed with illuminator 12. By way of example only, occasioning on illuminator 12 including a fluorescent lamp, illumination receiver 20 is optionally attached to, or integrally formed with, a “starter” 22. Thus, illuminators 12 including a fluorescent lamp can be readily modified for use with controller apparatus 10.

Fluorescent lamps known in the art, commonly use mercury atoms in the fluorescent tube, which mercury atoms, must be ionized before an arc can “strike” within the tube. For small lamps, it does not take much voltage to strike the arc and starting the lamp presents no problem, but larger tubes require a substantial voltage (in the range of a thousand volts). Thus, a variety of fluorescent lamps are known in the art which are generally divided into the following groups, according to their “starter” 22 technology: a preheat lamp, an automatic glow lamp, electronic fluorescent lamps, instant start lamps, rapid start lamps and semi-resonant start.

Preheat lamps known in the art use a combination filament/cathode at each end of the lamp in conjunction with a mechanical or automatic switch for initially connecting the filaments in series with the ballast and thereby preheat the filaments prior to striking the arc.

Preheat lamp systems are commonly used as standard equipment in 200-240V countries (and for 100-120 Volt lamps up to about 30 watts), and generally use a glow starter. Before the 1960s, four-pin thermal starters and manual switches were also used. Electronic starters are also sometimes used with these electromagnetic ballast lamp fittings.

Automatic glow starters known in the art commonly consist of a small gas-discharge tube, containing neon and/or argon and fitted with a bi-metallic electrode. The special bi-metallic electrode is the key to the automatic starting mechanism.

An electronic starter commonly uses a more complex method to preheat the cathodes of a fluorescent lamp. Electronic starters are commonly programmed with a predefined preheat time to ensure the cathodes are fully heated and reduce the amount of sputtered emission mix to prolong the life of the lamp. Electronic starters commonly contain a series of capacitors that are capable of producing a high voltage pulse of electricity across the lamp to ensure that it strikes correctly. Electronic starters are also commonly able to detect when a lamp has failed to strike and provide a further amount of high voltage pulses before reverting to an open circuit if that lamp still fails to strike, thereby substantially eliminating the re-striking of a lamp and the cycle of flashing that a failing lamp installed with a glow starter can produce.

Commonly, when starting a lamp with an electronic fluorescent lamp starter, a glow discharge will appear over the electrodes of the starter. The glow discharge will heat the gas in the starter and cause the bi-metallic electrode to bend towards the other electrode. When the electrodes touch, the two filaments of the fluorescent lamp and the ballast will effectively be switched in series to the supply voltage, thereby enabling the filaments to glow and emit electrons into the gas column by thermionic emission. In the starter's tube, the touching electrodes have stopped the glow discharge, causing the gas to cool down again. The bi-metallic electrode also cools down and starts to move back. When the electrodes separate, the inductive kick from the ballast provides the high voltage to start the lamp. The starter additionally has a capacitor wired in parallel to its gas-discharge tube, in order to prolong the electrode life.

Once the tube is struck, the impinging main discharge then keeps the cathode hot, permitting continued emission without the need for the starter to close. The starter does not close again because the voltage across the starter is reduced by the resistance in the cathodes and ballast. The glow discharge in the starter will not happen at the lower voltage so it will not warm and thus close the starter.

Commonly, tube strike are generally reliable in these systems, but glow starters will often cycle a few times before letting the tube stay lit, which causes undesirable flashing during starting. (The older thermal starters performed better in this respect.)

If the tube fails to strike, or strikes but then extinguishes, the starting sequence is repeated. With automated starters such as glow starters, a failing tube will cycle endlessly, flashing as the lamp quickly goes out because emission is insufficient to keep the lamp current high enough to keep the glow starter open, thereby bringing about a “flickering”, and operation of the ballast at above design temperature. Some more advanced starters time known in the art do not attempt repeated starts until power is reset. Some older systems used a thermal over-current trip to detect repeated starting attempts. These require manual reset.

Some instant start fluorescent tubes simply use a high enough voltage to break down the gas and mercury column and thereby start arc conduction. These tubes can be identified by a single pin at each end of the tube. The lamp holders have a “disconnect” socket at the low-voltage end to prevent electric shock. Low-cost lighting fixtures with an integrated electronic ballast use this mode on preheat-style lamps, even if it reduces the lamp lifespan.

Newer systems include rapid start ballast designs for providing filament power windings within the ballast; these rapidly and continuously warm the filaments/cathodes using low-voltage AC. No inductive voltage spike is produced for starting, so the lamps must be mounted near a grounded (earthed) reflector to allow the glow discharge to propagate through the tube and initiate the arc discharge. In some lamps a “starting aid” strip of grounded metal is attached to the outside of the lamp glass.

Semi-resonant start lamps known in the art were invented by Thorn Lighting for use with T12 fluorescent tubes, the semi-resonant starting method commonly uses a double wound transformer and a circuit capacitor to start the lamp without flashing and flickering. The lamp slowly starts over a period of about 3-5 seconds until it reaches full brightness without flickering.

Preferably, controller apparatus 10 has a shape recalling that of a standard motion detector 18.

Preferably, transmitter 16 is responsive to signals received from telemetry sensor 14.

The term “telemetry” as used herein includes, but is not limited to a technology for readily facilitating remote measurement and/or reporting of information, automatic transmission and/or measurements from remote sources by wire or radio or wirelessly.

By way of example only, the term “telemetry sensor” as used herein includes but is not limited to: motion detection by way of PIR technology, microwave technology, ultrasonic technology or any combination thereof.

Controller aparatus 10 is preferably capable of interpreting data collected from telemetry sensor 14 and use of data from telemetry sensor 14 to control and/or optimize the performance and/or energy consumption of controlled equipment and appliances. Preferably, controller aparatus 10 readily facilitates calculation of potentially enhanced and/or optimized energy consumption levels, such that a user and/or controller aparatus 10 can elect to use a management mode consistent with achieving enhanced and/or optimized energy consumption. Some examples of useful measurements from telemetry sensor 14 include, but are not limited to, motion detection, occupancy detection, consumption of electricity, temperature readings, volume detection and the like. By way of example only, a temperature reading is used to change the “setpoint” of at least one controlled HVAC appliance. Moreover, detecting the temperature and transmitting the temperature reading to the HVAC appliance is geared towards enhanced accuracy in achieving room temperature. Furthermore, electricity consumption information detected is used in extrapolating and interpolating data for the purpose of optimizing energy consumption. Furthermore, electricity consumption information detected is used to readily confirm the system has executed commands, such that the HVAC appliance has been initiated, ceassated or performed a change in mode of operation.

In addition, it is envisaged to use “two way” telemetry is facilitated wherein transmitter 16 is attached to, or integrally formed with, a controller apparatus receiver 24.

Optionally, controller receiver 24 is a receiver selected from the group consisting of: an infrared receiver, a wi-fi receiver, a Bluetooth receiver, an Ultra wide band (UWB) receiver, a proprietary ISM band receiver and the like.

Preferably, two way telemetry is achieved by way of updating and calibrating on substantially contemporaneously with the receipt of signals from telemetry sensor 14.

Preferably, illuminator 12 is a light emitting diode (“LED”) for readily emitting a visible, an IR illumination, and a UV illumination.

Preferably, illuminator 12 illuminates at a bandwidth substantially between 380-750 nm.

Preferably, illuminator 12 illuminates at a bandwidth substantially between 620-670 nm.

Preferably, illuminator 12 illuminates at a bandwidth substantially between 500-580 nm.

Preferably, illuminator 12 illuminates at a bandwidth substantially between 700-1400 nm.

Preferably, illuminator 12 illuminates at a bandwidth substantially between 1400-3000 nm.

Preferably, illuminator 12 illuminates at a bandwidth substantially between 3000 nm-1 mm.

Alternatively, illuminator 12 is a bulb, which bulb is constructed of such desired shape and size so as to fit within the physical contours of a light bulb.

Optionally, illuminator 12 is a laser diode for readily emitting coherent electro-magnetic radiation.

Optionally, transmitter 16 of controller apparatus 10 readily communicates with an HVAC (heating, ventilating and cooling) apparatus 26 for readily controlling operation and activity of HVAC apparatus 26. Preferably, first controller 10 controls operation of HVAC apparatus 26 according to reading of telemetry sensor 14.

Preferably, controller apparatus 10 is retrofittable to existing HVAC apparatus 26 substantially without having recourse to making any changes to HVAC apparatus 26.

Thus, controller apparatus 10 readily facilitates use of HVAC apparatus 26 according to factory designated features. Namely, controller apparatus 10 preferably “seamlessly” integrates with the use of HVAC apparatus 26.

Furthermore, controller apparatus 10 is preferably responsive to a reading of telemetry sensor 14 selected from the group consisting of: a change in the occupancy of domestic environment 11, a change in movement detectability in domestic environment 11, a detection of an audible noise in domestic environment 11 and a detectable change in ambient light.

Optionally, transmitter 16 of controller apparatus 10 readily communicates with a television apparatus 28 for readily controlling operation and activity of television apparatus 28. Preferably, controller apparatus 10 controls operation of television apparatus 28 according to reading of telemetry sensor 14.

Thus, controller apparatus 10 readily facilitates use of television apparatus 28 according to factory designated features. Namely, controller apparatus 10 preferably “seamlessly” integrates with the use of television apparatus 28.

Optionally, transmitter 16 of controller apparatus 10 readily communicates with a home theater system 30 for readily controlling operation and activity of home theater system 30. Preferably, controller apparatus 10 controls operation of home theater system 30 according to reading of telemetry sensor 14.

Thus, controller apparatus 10 readily facilitates use of home theater system 3 according to factory designated features. Namely, controller apparatus 10 preferably “seamlessly” integrates with the use of home theater system 30.

Optionally, transmitter 16 of controller apparatus 10 readily communicates with a multimedia system 32 for readily controlling operation and activity of multimedia system 32. Preferably, controller apparatus 10 controls operation of multimedia system 32 according to reading of telemetry sensor 14.

Thus, controller apparatus 10 readily facilitates use of multimedia system 32 according to factory designated features. Namely, controller apparatus 10 preferably “seamlessly” integrates with the use of multimedia system 32.

Optionally, transmitter 16 of controller apparatus 10 readily communicates with a computer 34 for readily controlling operation and activity of computer 34. Preferably, controller apparatus 10 controls operation of computer 34 according to reading of telemetry sensor 14.

Thus, controller apparatus 10 readily facilitates use of home theater system 32 according to factory designated features. Namely, controller apparatus 10 preferably “seamlessly” integrates with the use of computer 34.

Optionally, transmitter 16 of controller apparatus 10 readily communicates with an audio apparatus 36 for readily controlling operation and activity of audio apparatus 36. Preferably, controller apparatus 10 controls operation of audio apparatus 36 according to reading of telemetry sensor 14.

Thus, controller apparatus 10 readily facilitates use of audio apparatus 36 according to factory designated features. Namely, controller apparatus 10 preferably “seamlessly” integrates with the use of audio apparatus 36.

Optionally, transmitter 16 of controller apparatus 10 readily communicates with an image capturing apparatus 38 for readily controlling operation and activity of image capturing apparatus 38. Preferably, controller apparatus 10 controls operation of image capturing apparatus 38 according to reading of telemetry sensor 14.

Thus, controller apparatus 10 readily facilitates use of image capturing apparatus 38 according to factory designated features. Namely, controller apparatus 10 preferably “seamlessly” integrates with the use of image capturing apparatus 38.

Optionally, transmitter 16 of controller apparatus 10 readily communicates with a portable computing apparatus 40 for readily controlling operation and activity of portable computing apparatus 40. Preferably, controller apparatus 10 controls operation of portable computing apparatus 40 according to reading of telemetry sensor 14.

Thus, controller apparatus 10 readily facilitates use of portable computing apparatus 40 according to factory designated features. Namely, controller apparatus 10 preferably “seamlessly” integrates with the use of portable computing apparatus 40.

Optionally, transmitter 16 of controller apparatus 10 readily communicates with a telecommunications device 42 for readily controlling operation and activity of telecommunications device 42. Preferably, controller apparatus 10 controls operation of telecommunications device 42 according to reading of telemetry sensor 14.

Thus, controller apparatus 10 readily facilitates use of telecommunications device 42 according to factory designated features. Namely, controller apparatus 10 preferably “seamlessly” integrates with the use of telecommunications device 42.

Preferably and by way of example only, a controller PDA 43 wirelessly communicates with controller 10. PDA 43 is preferably geared towards wirelessly change control modes of controller 10 such as but not limited to, changing requested delay time, setting operation bypass mode and setting to test mode where wireless reception and motion detection coverage can be tested, more over, PDA 43 is capable of reprogram controller 10 for firmware updates, further more, PDA 43 is capable of receiving reports from controller 10 such as but not limited to battery level, number and type of controlled appliances and equipments, controlled appliances and equipments status, calculated energy saved.

Preferably, controller 10 is continuously energized and consumes substantially little energy, thereby readily facilitating controller 10 being powered by a battery for an extended period of time.

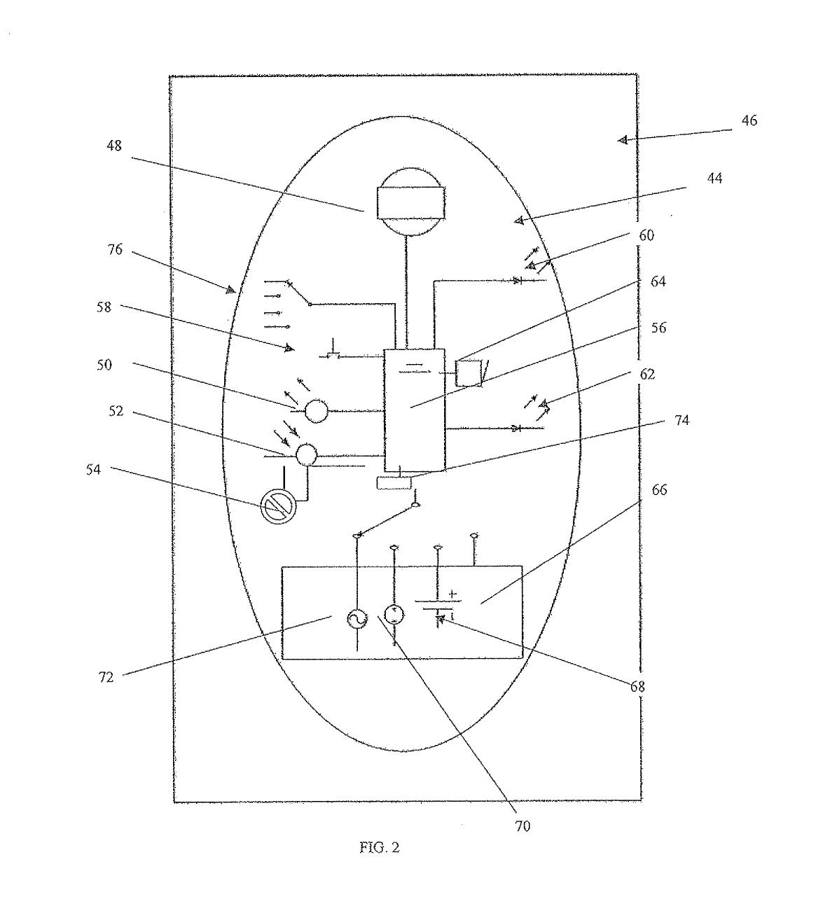

FIG. 2 shows a second controller 44 in an industrial and/or domestic environment 46. Second controller 44 is preferably electronically attached to, or integrally formed with, at least one device selected from the group consisting of a PIR sensor 48, a wireless transmitter 50. Preferably, second controller 44 is wirelessly attached to at least one electric/electronic apparatus selected from the group consisting of: a HVAC (heating, ventilating and cooling) apparatus, a telephony apparatus, a multimedia apparatus, an audio apparatus, a home theater system, at least one illumination device, a home computer, a portable computer and a PDA.

Optionally, wireless transmitter 50 is a transmitter selected from the group consisting of: an infrared transmitter, a wi-fi transmitter, a Bluetooth transmitter, an Ultra wide band (UWB) transmitter, a proprietary ISM band transmitter and the like.

Preferably, second controller 44 has a shape recalling that of a standard motion detector.

Preferably, wireless transmitter 50 is responsive to signals received from PIR sensor 48.

Second controller 44 is preferably capable of interpreting data collected from PIR sensor 48 and use of data from PIR sensor 48 to control and/or optimize at least one electric/electronic apparatus selected from the group consisting of: a HVAC (heating, ventilating and cooling) apparatus, a telephony apparatus, a multimedia apparatus, an audio apparatus, a home theater system, at least one illumination device, a home computer, a portable computer and a PDA.

Preferably, second controller 44 readily facilitates calculation of potentially enhanced and/or optimized energy consumption levels, such that a user and/or second controller 44 can elect to use a management mode consistent with achieving enhanced and/or optimized energy consumption. Some examples of useful measurements from PIR sensor 48 include, but are not limited to, motion detection, occupancy detection, consumption of electricity, temperature readings, volume detection and the like.

In addition, it is envisaged to use “two way” telemetry is facilitated wherein wireless transmitter 50 is attached to, or integrally formed with, a second controller receiver 52.

Preferably, two way telemetry is achieved by way of updating and calibrating on substantially contemporaneously with the receipt of signals from PIR sensor 48. Preferably, second controller 44 is responsive to signals from a learning remote control 54. Alternatively, second controller 44 readily communicates with learning remote 54 for the purpose of readily interfacing with appliance and electric/electronic apparatus without having recourse to retrofitting the appliance and electric/electronic apparatus. A variety of learning remote controls technologies are known in the art, universal remote controls facilitate use of code lists programmed into the remote for supporting new brands or models of devices not supported by the remote. Some higher end universal learning remotes require a computer to be connected. The connection is typically done via USB from the computer to mini-USB on the remote or the remotes base station.

IR learning remotes can learn the code for any button on many other IR remote controls. This functionality allows the remote to learn functions not supported by default for a particular device, making it sometimes possible to control devices that the remote was not originally designed to control.

In the 1980s Steve Wozniak of Apple, started a company named CL 9. The purpose of this company was to create a remote control which could operate multiple electronic devices. The CORE unit as it was named (Controller Of Remote Equipment) was introduced in the fall of 1987. The advantage to this remote controller was that it could “learn” remote signals from other different devices. It also had the ability to perform specific or multiple functions at various times with its built in clock. It was also the first remote control which could be linked to a computer and loaded with updated software code as needed.

The CORE unit did not make a huge impact on the market. The CORE unit was too cumbersome for the average user to program, but received rave reviews from those who could figure out how to program it. These obstacles eventually led to the demise of CL 9, but one of its employees continued the business under the name Celadon. This was one of the first computer controlled learning remote controls on the market.

Most control remotes for electronic appliances use a near infrared diode to emit a beam of light that reaches the device. A 940 nm wavelength LED is typical. This infrared light is invisible to the human eye, but picked up by sensors on the receiving device. Video cameras see the diode as if it produces visible purple light.

With a single channel (single-function, one-button) remote control the presence of a carrier signal can be used to trigger a function. For multi-channel (normal multi-function) remote controls more sophisticated procedures are necessary: one consists of modulating the carrier with signals of different frequency. After the demodulation of the received signal, the appropriate frequency filters are applied to separate the respective signals. Nowadays digital procedures are more commonly used. One can often hear the signals being modulated on the infrared carrier by operating a remote control in very close proximity to an AM radio not tuned to a station.

Different manufacturers of infrared remote controls use different protocols to transmit the infrared commands. The RC-5 protocol that has its origins within Philips, uses, for instance, a total of 14 bits for each button press. The bit pattern is modulated onto a carrier frequency that, again, can be different for different manufacturers and standards, in the case of RC-5, a 36 kHz carrier is being used. Other consumer infrared protocols are, for instance, the different SIRCS versions used by Sony, the RC-6 from Philips, or the NEC TC101 protocol.

By way of example only, remote controls are commonly used in the industry for controlling substations, pump storage power stations and HVDC-plants. For these systems often PLC-systems working in the longwave range are used.

Optionally, wireless transmitter 50 of second controller 44 readily communicates with an electric/electronic apparatus selected from the group consisting of: a HVAC (heating, ventilating and cooling) apparatus, a telephony apparatus, a multimedia apparatus, an audio apparatus, a home theater system, at least one illumination device, a home computer, a portable computer and a PDA.

Preferably, second controller 44 controls, according to readings of PIR sensor 48, the operation of an electric/electronic apparatus selected from the group consisting of: a HVAC (heating, ventilating and cooling) apparatus, a telephony apparatus, a multimedia apparatus, an audio apparatus, a home theater system, at least one illumination device, a home computer, a portable computer and a PDA. Preferably, second controller 44 is retrofittable to an existing electric/electronic apparatus substantially without having recourse to making any changes to an electric/electronic apparatus selected from the group consisting of: a HVAC (heating, ventilating and cooling) apparatus, a telephony apparatus, a multimedia apparatus, an audio apparatus, a home theater system, at least one illumination device, a home computer, a portable computer and a PDA.

Thus, second controller 44 readily facilitates use, according to factory designated features. Namely, second controller 44 preferably “seamlessly” integrates with the use of an electric/electronic apparatus selected from the group consisting of: a HVAC (heating, ventilating and cooling) apparatus, a telephony apparatus, a multimedia apparatus, an audio apparatus, a home theater system, at least one illumination device, a home computer, a portable computer and a PDA. Furthermore, second controller 44 is preferably responsive to a reading of PIR sensor 48 selected from the group consisting of: a change in the occupancy of industrial and/or domestic environment 46, a change in movement detectability in industrial and/or domestic environment 46, a detection of an audible noise in industrial and/or domestic environment 46 and a detectable change in ambient light.

Preferably, second controller 44 includes a processor module 56 for readily processing data from PIR sensor 48.

Preferably, processor 56 readily facilitates selection of a working mode of second controller 44 selected from the group consisting of: a standby mode, a hibernate mode, a power saving mode, an unoccupied mode and an “off” mode.

Preferably second controller includes a technician module 58 for readily bringing about a second controller 44 mode change selected from the group consisting of: a test mode, a learning mode, a transmission test mode, a PIR sensor test mode, an efficiency feedback mode, an electricity saving report mode and a use report mode.

A first LED 60 is preferably attached to, or integrally formed with second controller 44 for preferably readily facilitating an indication selected from the group consisting of: a working mode indication, a transmission indication, a movement detection indication, a fault indication, a weak battery indication, time mode selection indication and a reception indication.

A second LED 62 preferably attached to, or integrally formed with second controller 44 for preferably readily facilitating an indication selected from the group consisting of: a working mode indication, a transmission indication, a movement detection indication, a fault indication, a weak battery indication, time mode selection indication and a reception indication.

An indicator 64 is preferably attached to, or integrally formed with second controller 44 for preferably readily facilitating an indication selected from the group consisting of: an audio indication prior to second controller 44 altering the operation of an electric/electronic apparatus in industrial and/or domestic environment 46 and a video indication prior to second controller 44 altering the operation of an electric/electronic apparatus in industrial and/or domestic environment 46. Thus, a user may opt to prevent second controller 44 altering the operation of an electric/electronic apparatus in industrial and/or domestic environment 46.

A power supply 66 preferably powers second controller 44. Preferably, power supply 66 preferably includes a battery 68. Optionally, power supply 66 preferably includes a DC supply 70. Optionally, power supply 66 preferably includes an AC supply 72.

Preferably, a voltage regulator 74 connects between power supply 66 and powers second controller 44. By way of example only, voltage regulator 74 optionally includes a transformer attached to, or integrally formed with, voltage regulator 74.

Preferably, a time selector 76 is attached to, or integrally formed with processor 56 for readily controlling the time frame before changing one or more controlled electric/electronic apparatus operation mode.

Preferably, PIR sensor 48 provides an operational signal, indicating industrial and/or domestic environment 46 to processor 56. Alternatively, PIR sensor 48 provides an operational signal, indicating industrial and/or domestic environment is not occupied, to processor 56.

By way of example only, occasioning on a motion being detected by PIR sensor 48, processor unit 56 resets a counter. Occasioning on, PIR sensor 48 not detecting a motion for a predetermined and/or user selected time frame wireless transmitter 50 transmits a signal responsively to processor 56 to the electric/electronic apparatus for the purpose of the electric/electronic apparatus initiating a working mode selected from the group consisting of: a standby mode, a hibernate mode, an unoccupied mode, an power saving mode and an “off” mode.

Preferably, processor 56 will then initiate a standby mode, power save mode or a hibernate mode for processor 56 for saving energy.

Preferably, occasioning on PIR sensor 48 detecting a change in industrial and/or domestic environment 46, processor 56 initiates a “wake up” cycle. Namely, when an “external interrupt” is sensed by PIR sensor 48 such as, but not limited to, a motion detected, a displacement of a button or a reception of a wireless signal received, processor 56 initiates a “wake up” cycle.

It is envisaged that a multiplicity of second controllers 44 may be used in conjunction with a multiplicity of industrial and/or domestic environments 46, thereby readily controlling a wide range of electric/electronic apparatus, appliances and the like over a wide scale area.

It is further envisaged that the invention as described herein, controller 10 or second controller 44 can be readily included in an alarm system utilizing PIR sensors, motion detectors and the like.

It will be appreciated that the above descriptions are intended to only serve as examples, and that many other embodiments are possible within the spirit and scope of the present invention.

What is claimed is:

1. A controller system comprising:
(a) a controller apparatus including:
(i) a power source;
(ii) a telemetry sensor for readily detecting at least one telemetry reading;
(iii) a transmitter responsive to signals from said telemetry sensor; and
(b) an electrical/electronic apparatus responsive to signals from said transmitter.

2. The controller apparatus of claim 1, wherein the controller apparatus has a shape recalling that of a motion detector.

3. The controller apparatus of claim 1, wherein said transmitter wirelessly communicates with said electrical/electronic apparatus.

4. The controller of claim 1, wherein said electrical/electronic apparatus is devoid of retrofitting for readily using said controller apparatus with said apparatus.

5. The controller system of claim 1, wherein said electrical/electronic apparatus is selected from the group consisting of a HVAC (heating, ventilating and cooling) apparatus, a telephony apparatus, a multimedia apparatus, an audio apparatus, a home theater system, at least one illumination device, a home computer, a portable computer and a PDA.

6. A controller system comprising:
(a) a controller apparatus having a shape recalling that of a motion detector comprising:
(i) a power source;
(ii) a telemetry sensor for readily detecting at least one telemetry reading;
(iii) a wireless transmitter responsive to signals from said telemetry sensor;
(b) an electrical/electronic apparatus devoid of retrofitting to said controller and responsive to at least one signal from said transmitter;
wherein said electrical/electronic apparatus is selected from the group consisting of: a HVAC (heating, ventilating and cooling) apparatus, a telephony apparatus, a multimedia apparatus, an audio apparatus, a home theater system, at least one illumination device, a home computer, a portable computer and a PDA.

7. The controller apparatus of claim 6, wherein said telemetry sensor further comprising a processor for readily controlling the time and/or operation mode of said electrical/electronic apparatus.

8. The controller system of claim 6, wherein said illumination device illuminates substantially at a wavelength producing visible red, visible blue, IR or UV illumination.

9. The controller of claim 6, wherein said controller apparatus further comprising a receiver for “two way” telemetry with said controller.

10. The controller of claim 6, wherein said at least one signal is compatible with at least one domestic appliance.

11. (canceled)

12. A controller system comprising:
(a) a controller apparatus comprising:
(i) a power source; and
(ii) a wireless transmitter;
(b) an illuminator electrically attached responsive to at least one signal from said wireless transmitter; and
(c) an actuator electrically attached to said illuminator for readily controlling illumination of said illuminator.

13. The controller of claim 12, wherein said illuminator illuminates substantially at a wavelength producing visible red, visible blue, IR or UV illumination.
